(19) United States
(12) Patent Application Publication
(10) Pub. No.: US 2001/0035270 A1
(43) Pub. Date: Nov. 1, 2001

(54) Plate-shaped insert part for roller blinds or other profiles three

(76) Inventor: Gunther Erber, Ebental (Karnten) (AT)

Correspondence Address: YOUNG & THOMPSON, 745 SOUTH 23RD STREET 2ND FLOOR, ARLINGTON, VA, 22202

(21) Appl. No.: 09/797,588

(22) Filed: Mar. 5, 2001

(30) Foreign Application Priority Data
Mar. 3, 2000 (AT) A 347/2000

(51) Int. Cl. E06B 9/08

(52) U.S. Cl. 160/133

(57) ABSTRACT

An insert part which can be inserted into the ends of the rods of roller blinds or other profiles and is used to join to the chain links of a pull and adjustment chain of the roller blind comprises a plate-shaped part (1) which has a section (7, 14) which is to be inserted into the roller blind rod and a bent section (5) which is opposite the section (7, 14) to be inserted and to which the chain links (21, 22) can be connected.

The invention relates to an insert part which can be inserted into the ends of the rods of roller blinds or other profiles and which is used to join to the chain links of a pull and adjustment chain of the roller blind.

The rods of louvered roller blinds are on the one hand connected to a pull chain and on the other to an adjustment chin, and this connection must on the one hand be fabricated technically with very great precision in order to prevent sticking of the blind, and on the other hand in manufacture and installation it requires a relatively high proportion in terms of time consumption and costs.

Therefore the object of the invention is to execute this connection between the rods of the roller blinds and the pull and adjustment chain in a manner as reliable and economical as possible.

This object is achieved with an insert part which can be inserted into the ends of the rods of roller blinds or other profiles and is used to join to the chain links of a pull and adjustment chain of the roller blind, which is characterized in that it consists of a plate-shaped part which has a section which is to be inserted into the roller blind rod and a bent section which is opposite the section to be inserted and to which the chain links can be connected.

The insert part as claimed in the invention can be produced very easily. It can be punched for example out of spring steel sheet, whereupon the section to which the chain links are to be connected is bent in order to then be pressed or inserted into the roller blind rod.

The insert part as claimed in the invention is suited especially for roller blinds which are built as described in WO 95/18295.

Another advantage of the insert part as claimed in the invention is that it can elastically deflect the forces which occur due to the choice of shape and material without residual deformations occurring.

In one preferred embodiment of the invention the insert part is characterized in that the width of the section to be inserted decreases toward its end, its being especially preferred if the section with the diminishing width has a first wedge-shaped area with a smaller wedge angle which adjoins a second wedge-shaped area with a larger wedge angle.

Due to the width of the section to be inserted, which width decreases towards its end, and especially due to the conical area with the larger wedge angle, the insert part can be inserted very easily into the roller blind rod, its automatically centering itself. The wedge-shaped area with the larger wedge angle adjoins a section with a smaller wedge angle which in the insertion process causes possible widening and matching of the profile of the blind rod to the insertion part.

If in a further preferred embodiment of the invention the section to be inserted between the wedge-shaped section and the middle part has a section with a constant width, a solid and precision seat of the insert part in the roller blind rod is ensured by this section with a constant width.

Alternatively or additionally it can be provided that on at least one lengthwise edge of the section to be inserted there is at least one notch and that the edge on the notch on its end facing the bent area has a corner which is bent out. When the insert part is pressed in, at least one projecting edge is pressed into its original position which is flush with the lengthwise edge and is pressed under pretensioning into the softer material of the roller blind rod, where it acts like a barb against the insert part's being pulled out.

Other preferred embodiments of the invention are the subject matter of the other dependent claims.

In the following, preferred embodiments of the invention are detailed with reference to the attached drawings.

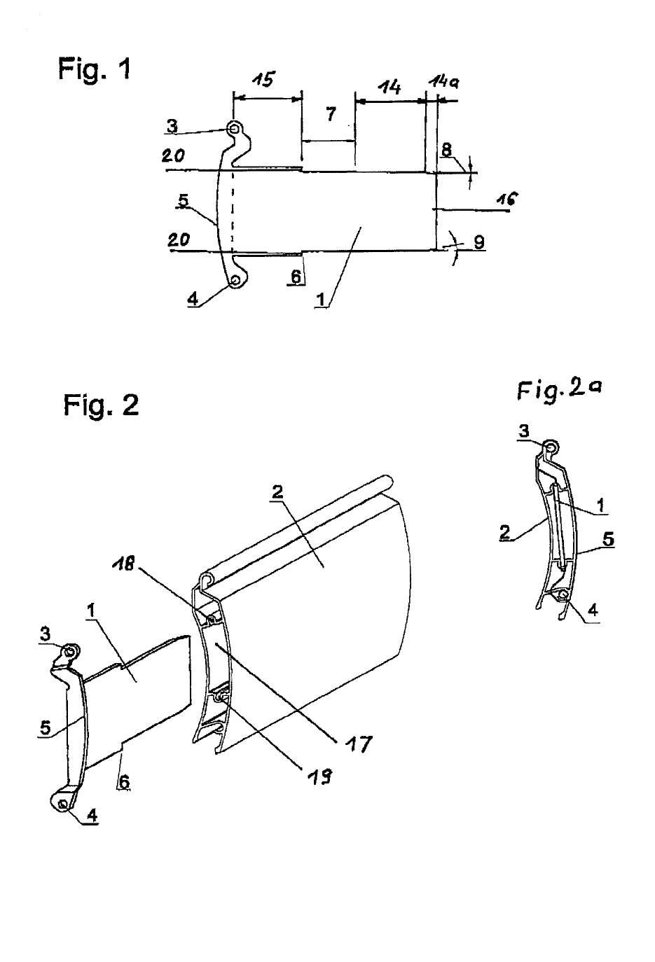

FIG. 1 shows the shape of the insert part after being punched out of a metal sheet;

FIG. 2 shows the insert part in its final shape, as can be inserted into the roller blind rod;

FIG. 2a shows a face view of a roller blind rod with an inserted insert part;

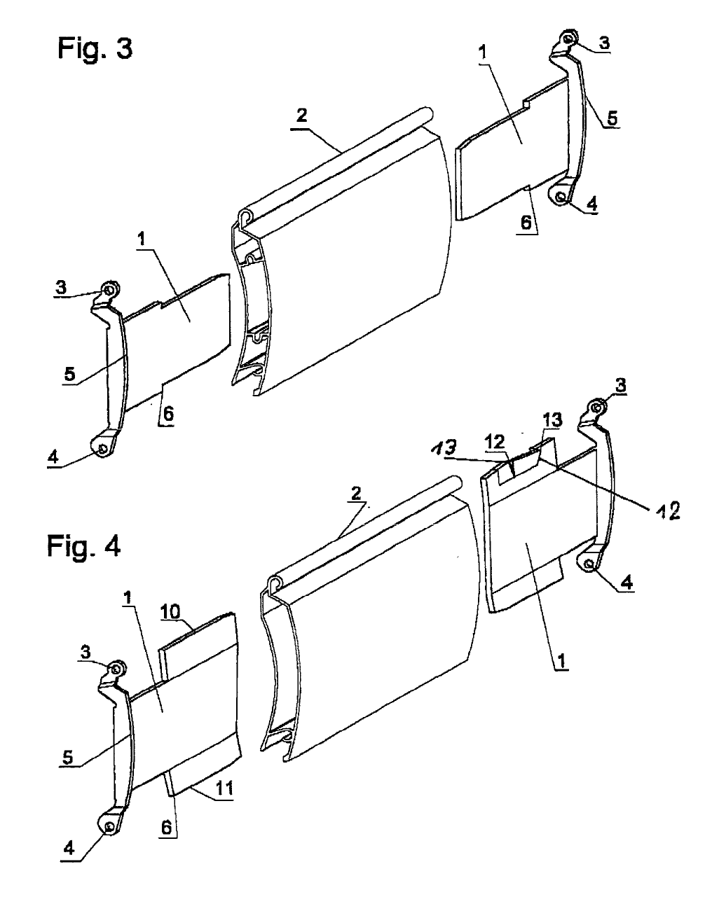

FIG. 3 shows a representation which corresponds to FIG. 2, on both ends of the roller blind rod an insert part being shown;

FIG. 4 shows a representation which corresponds to FIG. 3 with two other embodiments of the insert part as claimed in the invention; and

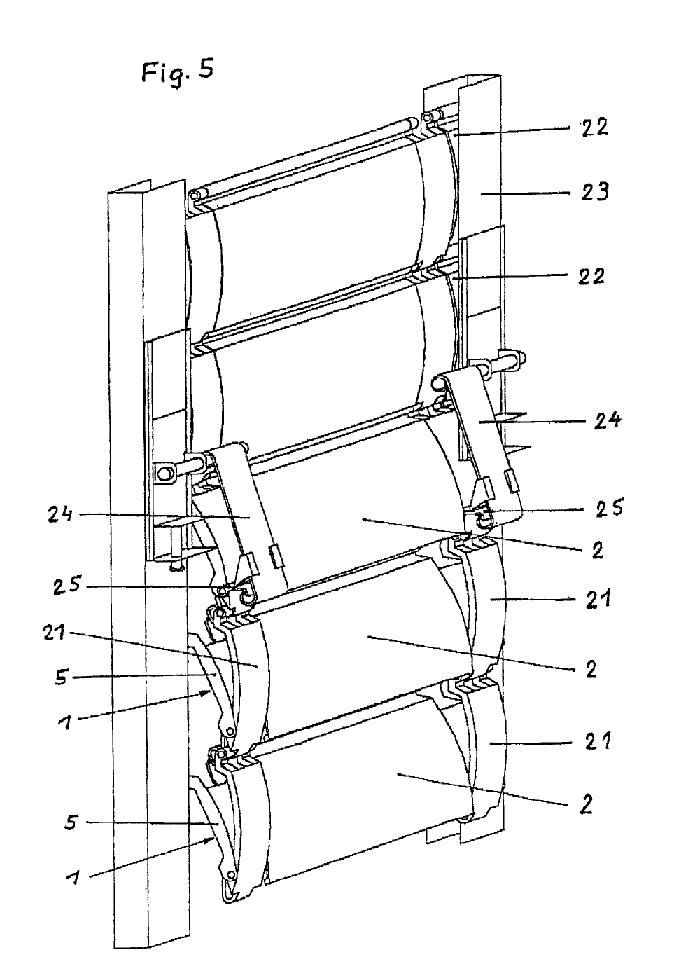

FIG. 5 shows an oblique view of a roller blind rod.

FIG. 1 shows one preferred embodiment of an insert part 1 as claimed in the invention which has been punched out of stainless spring steel and which consists of sections 7, 14 which are to be inserted into a roller blind rod 2 which is made as a hollow section, and a middle section or middle part 15 and a section 5 to be bent. The section 7 has a constant width, conversely section 14 is made in a wedge shape with a width which decreases towards the end 16. The section 14 adjoins on the end 16 another section 14a with a larger wedge angle 9.

Between the bent section 5 and the section 7 to be inserted with a constant width there is the middle part 15 which has a width which is greater than the width of the section 7.

When the insert part 1 is inserted into the hollow chamber 17 of the roller blind rod 2 the insert part 1 is first centered by the end section 14a with the larger wedge angle 9 in the guide grooves 18, 19. The insert part 1 is then further pressed into the grooves 18, 19 with the section 14 with the insert part 8, the walls of the grooves 18, 19 if necessary being slightly deformed to the top or bottom. The insert part 1 is then pushed as far as the stops 20 which are formed by the widening of the insert part 1 on the middle part 15.

The roller blind rod 2 can then be connected to an adjustment chain by means of a hole 3 on the section 5 with the pull chain and by means of a hole 4 which is located likewise on the bent section 5 of the insert part 1, the chain links 21 of the adjustment chains being located over the middle section 15, as shown by FIG. 5.

FIG. 4 shows two embodiments of insert parts 1 in which the section to be inserted into the roller blind rod 2 compared to the middle part 15 is widened by projections 10, 11. One such embodiment of the insert parts 1 can be used when the roller blind rods 2 do not have crosspieces with grooves 18, 19, as shown in FIGS. 2 and 3. In this embodiment the projections 10 and 11, as described above regarding FIGS. 1 to 3, can also have a rear section with a constant width, then adjoining can have a section with a small wedge angle and one end section with a large wedge angle which facilitate or improve the insertion and pressing of the insert part 1 in the profile rod 2.

The insert part 1 which is shown on the right in FIG. 4 has the particular feature that on the projection 10 on its lengthwise edge there are two notches 12, the lengthwise edge being bent on the corners 13 out of the plane of the insert part 1, which are then pressed into the softer material of the profile rod 2 when the insert part is inserted into the profile rod 2 and which prevent the insert part 1 from being pulled out.

FIG. 5 shows in an oblique view a roller blind in which the roller blind rods 2 are partially unfolded. The blind is guided via pull chain links 22 in stationary guides 23 on which hooks 24 are supported. These hooks 24 interact with counterpieces 25 which when connected to the insert parts 5 cause the roller blind rods 2 to be unfolded.

1. Insert part which can be inserted into the ends of the rods of roller blinds or other profiles and is used to join to the chain links of a pull and adjustment chain of the roller blind, characterized in that it consists of a plate-shaped part (1) which has a section (7, 14) which is to be inserted into the roller blind rod and a bent section (5) which is opposite the section (7, 14) to be inserted and to which the chain links (21, 22) can be connected.

2. Insert part as claimed in claim 1, wherein between the section (7, 14) to be inserted and the bent section (5) there is the middle part (15) which has a width which is greater than the width of the section (7, 14) to be inserted.

3. Insert part as claimed in claim 1 or 2, wherein the width of the section (7, 14) to be inserted decreases toward its end (16):

4. Insert part as claimed in claim 3, wherein the section with the diminishing width has a first wedge-shaped area (14) with a smaller wedge angle (8) which adjoins a second wedge-shaped area (14a) with a larger wedge angle (9).

5. Insert part as claimed in claim 4, wherein the section (7, 14) to be inserted between the wedge-shaped section (14) and the middle part (15) has a section (7) with a constant width.

6. Insert part as claimed in one of claims 1 to 5, wherein the insert part (1) is a sheet-metal stamping.

7. Insert part as claimed in one of claims 1 to 6, wherein the insert part (1) is produced from spring steel.

8. Insert part as claimed in one of claims 1 to 7, wherein on at least one lengthwise edge of the section to be inserted there is at least one notch (12) and that the edge on the notch (12) on its end (16) facing the bent area has a corner (13) which is bent out.

9. Insert part as claimed in claim 8, wherein on at least one lengthwise edge there is at least one notch (12) with a corner (13) which is bent out.

10. Insert part as claimed in one of claims 1 to 9, wherein the part (10, 11) to be inserted has a width which is greater than the width of the middle part (15).
